(19) United States
(12) Patent Application Publication
(10) Pub. No.: US 2024/0357966 A1
(43) Pub. Date: Oct. 31, 2024

(54) SYSTEMS AND METHODS FOR CALIBRATING AND DETECTING A GEAR POSITION OF A ROTOR ASSEMBLY

(71) Applicant: Deere & Company, Moline, IL (US)

(72) Inventors: Saravanan STALLIN, Chennai (IN); Ashwin POL, Wai (IN); Sujay SHITOLE, Pune (IN); Riley GROVES, East Moline, IL (US); Aaron DEUTCHMAN, Bettendorf, IA (US); William ECKMAN, Bettendorf, IA (US)

(73) Assignee: Deere & Company, Moline, IL (US)

(21) Appl. No.: 18/308,218

(22) Filed: Apr. 27, 2023

(51) Int. Cl. A01D 41/127

(52) U.S. Cl. CPC A01D 41/1274

(57) ABSTRACT

A non-transitory computer-readable medium storing instructions that, when executed by at least one processor, causes the at least one processor to perform a method. The method includes performing a gear calibration procedure, obtaining a gear setting based on the gear calibration procedure, and controlling a rotational speed of a rotor based on the obtained gear setting.

### FIELD

The present disclosure relates to systems and methods for calibrating and detecting a gear setting of a rotor assembly associated with an agricultural harvester.

### BACKGROUND

There are a wide variety of different types of agricultural machines. Some agricultural machines include harvesters, such as combine harvesters, sugar cane harvesters, cotton harvesters, self-propelled forage harvesters, and windrowers. Some harvesters may be fitted with different types of heads to harvest different types of crops.

After the crop is harvested, the agricultural material is transported to an interior portion of the harvester. The harvester includes a threshing assembly configured to thresh the harvested agricultural material. For example, the threshing assembly includes a rotor, such as a threshing rotor, for breaking up a material being harvested.

### SUMMARY

At least one example embodiment relates to a non-transitory computer-readable medium storing instructions that, when executed by at least one processor, causes the at least one processor to perform a method. The method includes performing a gear calibration procedure, obtaining a gear setting based on the gear calibration procedure, and controlling a rotational speed of a rotor based on the obtained gear setting.

In at least one example embodiment, the performing the gear calibration procedure includes activating the rotor; decreasing the rotational speed of the rotor; determining, as a first rotational speed, a rotational speed achieved by the rotor prior to plates of a variable drive unit experiencing a stall when the rotational speed of the rotor is decreased; increasing the rotational speed of the rotor; determining, as a second rotational speed, a rotational speed achieved by the rotor prior to the plates of the variable drive unit experiencing a stall when the rotational speed of the rotor is increased; and determining a current gear setting based on the first rotational speed and the second rotational speed.

In at least one example embodiment, the decreasing the rotational speed of the rotor includes reducing a hydraulic pressure delivered to the rotor and the increasing the rotational speed of the rotor includes increasing the hydraulic pressure delivered to the rotor.

In at least one example embodiment, the decreasing the rotational speed of the rotor includes increasing a distance between two side plates of a variable drive unit coupled to the rotor and the increasing to the rotational speed of the rotor includes decreasing the distance between the two side plates of the variable drive unit coupled to the rotor.

In at least one example embodiment, the determining the current gear setting includes comparing the first rotational speed and the second rotational speed to two or more gear thresholds.

In at least one example embodiment, the two or more gear thresholds include a first gear threshold and a second gear threshold. The current gear setting is a first gear if the first rotational speed is less than or equal to a lower limit of the second gear threshold and the second rotational speed is less than or equal to an upper limit of the first gear threshold. The current gear setting is a second gear if the second rotational speed is greater than or equal to an upper limit of the first gear threshold and the first rotational speed is greater than or equal to a lower limit of the second gear threshold.

In at least one example embodiment, the two or more gear thresholds include a first gear threshold, a second gear threshold, and a third gear threshold. The current gear setting is a first gear if the first rotational speed is less than or equal to a lower limit of the second gear threshold and the second rotational speed is less than or equal to an upper limit of the first gear threshold. The current gear setting is a second gear if the first rotational speed is less than or equal to a lower limit of the third gear threshold and the second rotational speed is less than or equal to upper limit of the second gear threshold. The current gear setting is the second gear if the second rotational speed is greater than or equal to an upper limit of the first gear threshold and the first rotational speed is greater than or equal to a lower limit of the second gear threshold. The current gear setting is a third gear if the second rotational speed is greater than or equal to the upper limit of the second gear threshold and the first rotational speed is greater than or equal to the lower limit of the third gear threshold.

At least one example embodiment relates to a system. The system includes a rotor assembly, a valve assembly communicatively coupled to the rotor assembly, and a controller communicatively coupled to the valve assembly. The controller is configured to perform a gear calibration procedure, obtain a gear setting based on the gear calibration procedure, and control a rotational speed of a rotor based on the obtained gear setting.

In at least one example embodiment, the gear calibration procedure includes activating the rotor; decreasing the rotational speed of the rotor; determining, as a first rotational speed, a rotational speed achieved by the rotor prior to plates of a variable drive unit experiencing a stall when the rotational speed of the rotor is decreased; increasing the rotational speed of the rotor; determining, as a second rotational speed, a rotational speed reached by the rotor prior to the plates of the variable drive unit experiencing a stall when the rotational speed of the rotor is increased; and determining a current gear setting based on the first rotational speed and the second rotational speed.

In at least one example embodiment, the decreasing the rotational speed of the rotor includes reducing a hydraulic pressure delivered to the rotor and the increasing the rotational speed of the rotor includes increasing a hydraulic pressure delivered to the rotor.

In at least one example embodiment, the obtained gear setting includes a first gear having a first gear threshold or a second gear having a second gear threshold.

In at least one example embodiment, the current gear setting is a first gear if the first rotational speed is less than or equal to a lower limit of the second gear threshold and the second rotational speed is less than or equal to an upper limit of the first gear threshold. The current gear setting is a second gear if the second rotational speed is greater than or equal to an upper limit of the first gear threshold and the first rotational speed is greater than or equal to a lower limit of the second gear threshold.

In at least one example embodiment, the obtained gear setting includes a first gear having a first gear threshold, a second gear having a second gear threshold, or a third gear having a third gear threshold.

In at least one example embodiment, the current gear setting is a first gear if the first rotational speed is less than or equal to a lower limit of the second gear threshold and the second rotational speed is less than or equal to an upper limit of the first gear threshold. The current gear setting is a second gear if the first rotational speed is less than or equal to a lower limit of the third gear threshold and the second rotational speed is less than or equal to an upper limit of the second gear threshold. The current gear setting is the second gear if the second rotational speed is greater than or equal to an upper limit of the first gear threshold and the first rotational speed is greater than or equal to a lower limit of the second gear threshold. The current gear setting is a third gear if the second rotational speed is greater than or equal to the upper limit of the second gear threshold and the first rotational speed is greater than or equal to the lower limit of the third gear threshold.

In at least one example embodiment, the system includes a sensor coupled to the rotor and configured to measure the rotational speed of the rotor.

At least one example embodiment relates to a method. The method includes performing a gear calibration procedure for a rotor assembly of an agricultural harvester, obtaining a gear based on the gear calibration procedure, and controlling a rotational speed of a rotor of the rotor assembly based on the obtained gear setting.

In at least one example embodiment, the gear calibration procedure includes activating the rotor; decreasing the rotational speed of the rotor; determining, as a first rotational speed, a rotational speed achieved by the rotor prior to plates of a variable drive unit experiencing a stall when the rotational speed of the rotor is decreased; increasing the rotational speed of the rotor; determining, as a second rotational speed, a rotational speed achieved by the rotor prior to the plates of the variable drive unit experiencing a stall when the rotational speed of the rotor is increased; and determining a current gear setting based on the first rotational speed and the second rotational speed.

In at least one example embodiment, the determining the current gear setting includes comparing the first rotational speed and the second rotational speed to a first gear threshold and a second gear threshold. The current gear setting is a first gear if the first rotational speed is less than or equal to a lower limit of the second gear threshold and the second rotational speed is less than or equal to an upper limit of the first gear threshold. The current gear setting is a second gear if the second rotational speed is greater than or equal to an upper limit of the first gear threshold and the first rotational speed is greater than or equal to a lower limit of the second gear threshold.

In at least one example embodiment, the determining the current gear setting includes comparing the first rotational speed and the second rotational speed to a third gear threshold. The current gear setting is a first gear if the first rotational speed is less than or equal to a lower limit of the second gear threshold and the second rotational speed is less than or equal to an upper limit of the first gear threshold. The current gear setting is a second gear if the first rotational speed is less than or equal to a lower limit of the third gear threshold and the second rotational speed is less than or equal to an upper limit of the second gear threshold. The current gear setting is the second gear if the second rotational speed is greater than or equal to an upper limit of the first gear threshold and the first rotational speed is greater than or equal to a lower limit of the second gear threshold. The current gear setting is a third gear if the second rotational speed is greater than or equal to the upper limit of the second gear threshold and the first rotational speed is greater than or equal to the lower limit of the third gear threshold.

In at least one example embodiment, the controlling the rotational speed of the rotor includes operating the rotor at a prior rotational speed value selected by an operator.

### BRIEF DESCRIPTION OF THE DRAWINGS

The various features and advantages of the non-limiting embodiments herein may become more apparent upon review of the detailed description in conjunction with the accompanying drawings. The accompanying drawings are merely provided for illustrative purposes and should not be interpreted to limit the scope of the claims. The accompanying drawings are not to be considered as drawn to scale unless explicitly noted. For the purposes of clarity, various dimensions of the drawings may have been exaggerated.

FIG. 1A is a schematic diagram of an agricultural harvester in accordance with at least one example embodiment.

FIG. 1B is a diagram of a system for controlling and calibrating a gear setting for a rotor of the agricultural harvester of FIG. 1A in accordance with at least one example embodiment.

FIG. 2 is a flow chart of a method for operating a rotor of the agricultural harvester in accordance with at least one example embodiment.

FIG. 3 is a flow chart of a gear calibration method for the rotor of the agricultural harvester in accordance with at least one example embodiment.

### DETAILED DESCRIPTION

Agricultural harvesters may be fitted with different types of heads for harvesting various types of crops. After the crop is harvested, the agricultural material is transported to an interior portion of the harvester. The harvester includes a threshing assembly configured to thresh the harvested agricultural material. A rotor of the threshing assembly operates within a range of speeds based on a gear setting selected by an operator. Performance of the agricultural harvester and the rotor may be negatively affected based on various factors. For example, harvesting in areas with moisture in the crop can reduce the speed of the rotor. The reduction in rotational speed of the rotor caused by exterior factors, such as crop conditions, may result in the gear position being incorrectly detected. In another example, a reduction in hydraulic pressure, which may occur when hydraulic oil leaks while the agricultural harvester is powered off, may result in the gear setting being incorrectly detected. If the agricultural harvester detects the wrong gear setting, the operator is unable to operate the rotor at a speed within a range associated with the desired gear setting, which can negatively impact grain quality and result in undesirable machine down time. If the rotor is not operating within the range of the desired gear setting, the operator may need to power off the agricultural harvester entirely in order to manually adjust to the desired gear setting.

Example embodiments provide improved systems and methods for calibrating a gear setting of a rotor with greater accuracy such that the rotor may be operated in a desired range of rotational speeds. For example, the gear setting may be accurately detected regardless of varying rotor speeds, moisture levels in the crop, and crop thickness or density. Efficiency and productivity of the agricultural harvester may also be improved. For example, accurate gear detection and calibration may result in less machine down time, improved grain quality, and reduced grain loss.

Some example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particular manner, a function or operation specified in a specific block may be performed differently from the flow specified in a flowchart, flow diagram, etc. For example, functions or operations illustrated as being performed serially in two consecutive blocks may actually be performed concurrently, simultaneously, contemporaneously, or in some cases be performed in reverse order.

It will be understood that when an element is referred to as being “connected” or “coupled” to another element, it may be directly connected or coupled to the other element or intervening elements may be present. As used herein the term “and/or” includes any and all combinations of one or more of the associated listed items.

Although terms of “first” or “second” may be used to explain various components (or parameters, values, etc.), the components (or parameters, values, etc.) are not limited to the terms. These terms should be used only to distinguish one component from another component. For example, a “first” component may be referred to as a “second” component, or similarly, and the “second” component may be referred to as the “first” component. Expressions such as “at least one of” when preceding a list of elements, modify the entire list of elements and do not modify the individual elements of the list. For example, the expression, “at least one of a, b, and c,” should be understood as including only a, only b, only c, both a and b, both a and c, both b and c, all of a, b, and c, or any variations of the aforementioned examples.

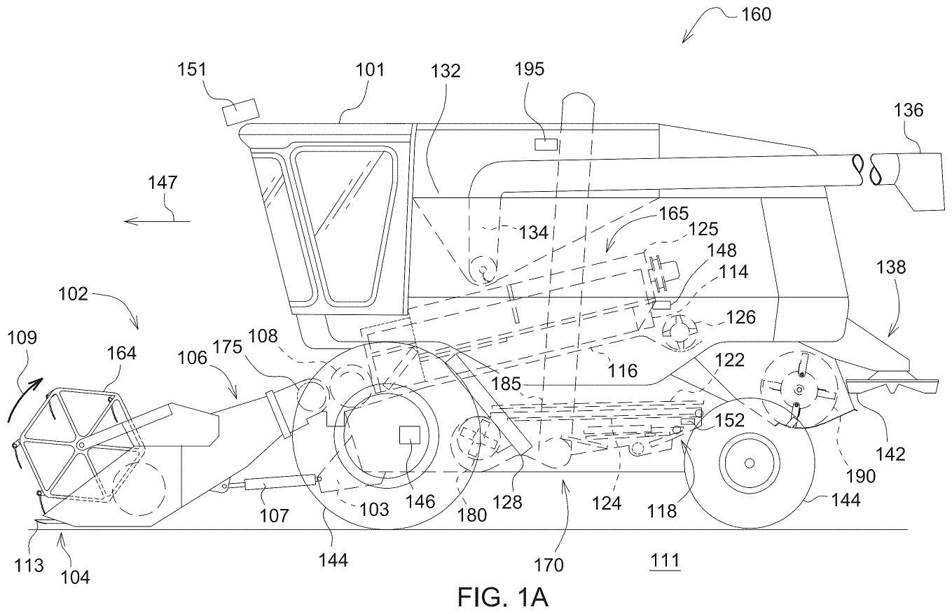

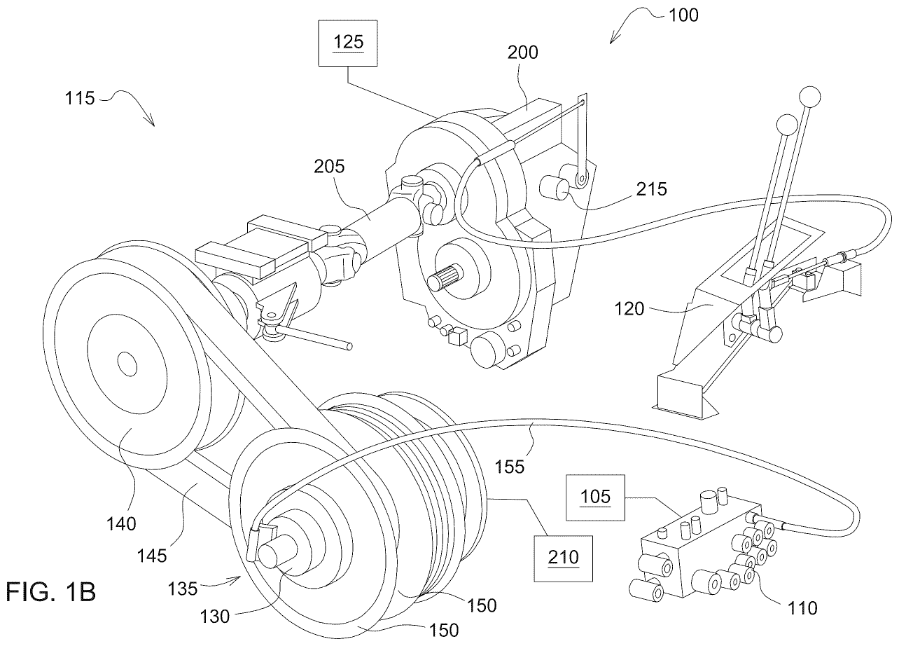

FIG. 1A is a schematic diagram of an agricultural harvester in accordance with at least one example embodiment.

In at least one example embodiment, an agricultural harvester, such as a harvester 160, may be a combine harvester, as shown in FIG. 1A. Although combine harvesters are provided as examples throughout the present disclosure, it will be appreciated that the present description is also applicable to other types of harvesters, such as cotton harvesters, sugarcane harvesters, self-propelled forage harvesters, windrowers, or other agricultural work machines. Consequently, the harvester 160 encompass the various types of harvesters described and is, thus, not limited to combine harvesters.

As shown in FIG. 1A, the harvester 160 includes an operator compartment 101, which may have a variety of different operator interface mechanisms for controlling the harvester 160. The harvester 160 may include front-end equipment, such as a header 102, and a cutter generally indicated at 104. In the illustrated example, the cutter 104 is included on the header 102. The harvester 160 may also include a feeder house 106, a feed accelerator 108, and/or a thresher generally indicated at 165. The feeder house 106 and the feed accelerator 108 may form part of a material handling subsystem 170. The header 102 may be pivotally coupled to a frame 103 of the harvester 160 along an axis 175. One or more actuators 107 (may be referred to herein in singular or plural form) may drive movement of the header 102 about the axis 175 in the direction generally indicated by an arrow 109. Thus, a vertical position of the header 102 (the header height) above ground 111 over which the header 102 travels is controllable by actuating the actuator 107. While not shown in FIG. 1A, the harvester 160 may also include one or more actuators that operate to apply a tilt angle, a roll angle, or both to the header 102 or portions of the header 102. Tilt refers to an angle at which the cutter 104 engages the crop. The tilt angle is increased, for example, by controlling the header 102 to point a distal edge 113 of the cutter 104 more toward the ground 111. The tilt angle may be decreased by controlling the header 102 to point the distal edge 113 of the cutter 104 more away from the ground 111. The roll angle refers to the orientation of the header 102 about the front-to-back longitudinal axis of the harvester 160.

The thresher 165 illustratively includes a rotor 125 and a set of concaves 114. Further, the harvester 160 may also include a separator 116. The harvester 160 may also include a cleaning subsystem or cleaning shoe (collectively referred to as cleaning subsystem 118) that may include a cleaning fan 180, a chaffer 122, and/or a sieve 124. The material handling subsystem 170 may also include a tailings elevator 128 and/or a clean grain elevator 185, as well as an unloading auger 134 and/or a spout 136. The clean grain elevator 185 may move clean grain into a clean grain tank 132. The harvester 160 may also include a residue subsystem 138 that may include a discharge beater 126, a chopper 190 and/or a spreader 142. The harvester 160 may also include a propulsion subsystem that may include an engine that drives ground engaging components 144, such as wheels or tracks. In some examples, a combine harvester within the scope of the present disclosure may have more than one of any of the subsystems mentioned above. In some examples, the harvester 160 may have left and right cleaning subsystems, separators, etc., which are not shown in FIG. 1A.

In operation, and by way of overview, the harvester 160 illustratively moves through a field in the direction indicated by arrow 147. As the harvester 160 moves, the header 102 (and an associated reel 164) may engage the crop to be harvested and gather the crop toward the cutter 104. An operator of the harvester 160 may be a local human operator, a remote human operator, and/or an automated system. An operator command is a command by an operator. The operator of the harvester 160 may determine one or more of a height setting, a tilt angle setting, and/or a roll angle setting for the header 102. For example, the operator may input a setting or settings to a control system, described in more detail below, that controls the actuator 107. The control system may also receive a setting from the operator for establishing the tilt angle and/or roll angle of the header 102 and implement the inputted settings by controlling associated actuators, not shown, that operate to change the tilt angle and/or roll angle of the header 102. The actuator 107 may maintain the header 102 at a height above the ground 111 based on a height setting and, where applicable, at desired tilt and/or roll angles. Each of the height, roll, and tilt settings may be implemented independently of the others. The control system may respond to header error (e.g., the difference between the height setting and measured height of the header 102 above the ground 111 and, in some examples, tilt angle and/or roll angle errors) with a responsiveness that is determined based on a selected sensitivity level. If the sensitivity level is set at a greater level of sensitivity, the control system may respond to smaller header position errors, and attempt to reduce the detected errors more quickly than when the sensitivity is at a lower level of sensitivity.

Returning to the description of the operation of the harvester 160, after crops are cut by cutter 104, the severed crop material may be moved through a conveyor in the feeder house 106 toward the feed accelerator 108, which accelerates the crop material into the thresher 165. The crop material may be threshed by the rotor 125 rotating the crop against the concaves 114. The threshed crop material may be moved by a separator rotor in the separator 116 where a portion of the residue may be moved by the discharge beater 126 toward the residue subsystem 138. The portion of residue transferred to the residue subsystem 138 may be chopped by the chopper 190 and spread on the field by the spreader 142. In other configurations, the residue may be released from the harvester 160 in a windrow. In other examples, the residue subsystem 138 may include weed seed eliminators (not shown) such as seed baggers or other seed collectors, or seed crushers or other seed destroyers.

Grain may fall to the cleaning subsystem 118. The chaffer 122 may separate some larger pieces of material from the grain, and the sieve 124 may separate some finer pieces of material from the clean grain. The clean grain may fall to an auger that may move the grain to an inlet end of the clean grain elevator 185, and the clean grain elevator 185 may move the clean grain upwards, depositing the clean grain in the clean grain tank 132. Residue may be removed from the cleaning subsystem 118 by airflow generated by the cleaning fan 180. The cleaning fan 180 may direct air along an airflow path upwardly through the sieves and chaffers. The airflow may carry residue rearwardly in the harvester 160 toward the residue subsystem 138.

The tailings elevator 128 may return tailings to the thresher 165 where the tailings are re-threshed. Alternatively, the tailings also may be passed to a separate re-threshing mechanism by a tailings elevator or another transport device where the tailings are re-threshed as well.

FIG. 1A also shows that, in one example, the harvester 160 may include a machine speed sensor 146, one or more separator loss sensors 148, a clean grain camera 195, a forward/rearward looking image capture mechanism 151, which may be in the form of a stereo or mono camera, one or more loss sensors 152 provided in the cleaning subsystem 118, and/or at least one sideways looking image capture mechanism 153 (may also be in the form of a stereo or mono camera).

The machine speed sensor 146 may sense the travel speed of the harvester 160 over the ground 111. The machine speed sensor 146 may sense the travel speed of the harvester 160 by sensing the speed of rotation of the ground engaging components (such as wheels or tracks), a drive shaft, an axel, or other components. In some instances, the travel speed may be sensed using a positioning system, such as a global positioning system (GPS), a dead reckoning system, a long range navigation (LORAN) system, or a wide variety of other systems or sensors that provide an indication of travel speed.

The loss sensors 152 illustratively provide an output signal indicative of the quantity of grain loss occurring in both the right and left sides of the cleaning subsystem 118. In some examples, the loss sensors 152 are strike sensors which count grain strikes per unit of time or per unit of distance traveled to provide an indication of the grain loss occurring at the cleaning subsystem 118. The strike sensors for the right and left sides of the cleaning subsystem 118 may provide individual signals or a combined or aggregated signal. In some examples, the loss sensors 152 may include a single sensor as opposed to separate sensors provided for each side of the cleaning subsystem 118. The separator loss sensors 148 may provide a signal indicative of grain loss in the left and right separators, not separately shown in FIG. 1A. The separator loss sensors 148 may be associated with the left and right separators and may provide separate grain loss signals or a combined or aggregate signal. In some instances, sensing grain loss in the separators may also be performed using a wide variety of different types of sensors as well.

The harvester 160 may also include other sensors and measurement mechanisms. For example, the harvester 160 may include one or more of the following sensors: a header height sensor that senses a height of the header 102 above the ground 111; stability sensors that sense oscillation or bouncing motion (and amplitude) of the harvester 160; a residue setting sensor that is configured to sense whether the harvester 160 is configured to chop the residue, produce a windrow, etc.; one or more sensors for detecting a residue spread performance of the harvester 160 or of another agricultural harvester (e.g., at least one camera, a Radar system, a Lidar system, etc.); a cleaning shoe fan speed sensor to sense the speed of the cleaning fan 180; a concave clearance sensor that senses clearance between the rotor 125 and the concaves 114; a threshing rotor speed sensor that senses a rotor speed of the rotor 125; a chaffer clearance sensor that senses the size of openings in the chaffer 122; a sieve clearance sensor that senses the size of openings in the sieve 124; a material other than grain (MOG) moisture sensor that senses a moisture level of the MOG passing through the harvester 160; one or more machine setting sensors configured to sense various configurable settings of the harvester 160; a machine orientation sensor that senses the orientation of the harvester 160; and/or crop property sensors that sense a variety of different types of crop properties, such as crop type, crop moisture, and/or other crop properties. Crop property sensors may also be configured to sense characteristics of the severed crop material as the crop material is being processed by the harvester 160. For example, in some instances, the crop property sensors may sense grain quality such as broken grain, MOG levels; grain constituents such as starches and protein; and/or grain feed rate as the grain travels through the feeder house 106, the clean grain elevator 185, or elsewhere in the harvester 160. The crop property sensors may also sense the feed rate of biomass through the feeder house 106, through the separator 116 or elsewhere in the harvester 160. The crop property sensors may also sense the feed rate as a mass flow rate of grain through the clean grain elevator 185 or through other portions of the harvester 160 or provide other output signals indicative of other sensed variables.

FIG. 1B is a diagram of a system for controlling and calibrating a gear setting for a rotor of the agricultural harvester of FIG. 1A in accordance with at least one example embodiment.

In at least one example embodiment, the harvester 160 may include a system 100 for controlling and calibrating a gear setting for the rotor 125. In at least one example embodiment, the system 100 may include a controller 105, a valve assembly 110, a rotor assembly 115, a gear selector 120, and the rotor 125. In at least one example embodiment, the operator of the harvester 160 may select the gear setting for the rotor 125 using the gear selector 120. For example, the gear selector 120 may include one or more levers, one or more switches, or a user interface for selecting the gear setting. In at least one example embodiment, the gear selector 120 is coupled to the rotor assembly 115. For example, the gear selector 120 may be coupled to a gear box 200 of the rotor assembly 115. The gear selector 120 may be configured to physically engage one of two or more gears of the gear box 200 of the rotor assembly 115. In at least one example embodiment, the gear setting may include at least a first gear and a second gear. In the first gear, the rotor 125 may be configured to operate at a rotational speed within a first gear threshold. In the second gear, the rotor 125 may be configured to operate at a rotational speed within a second gear threshold. In at least one example embodiment, the first gear threshold may be between about 210 revolutions per minute (RPM) to about 500 RPM and the second gear threshold may be between about 400 RPM to about 1000 RPM.

In at least one example embodiment, the controller 105 is communicatively coupled to the valve assembly 110. The controller 105 may be configured to control the rotational speed of the rotor 125 based on the selected gear setting. In at least one example embodiment, the controller 105 may be configured to control a hydraulic, electric, or other system coupled to the rotor assembly 115. For example, the controller 105 may control a supply of hydraulic fluid from the valve assembly 110 to the rotor assembly 115. In at least one example embodiment, the rotor assembly 115 includes a hydraulic cylinder 130 configured to control an effective diameter of a variable drive unit, such as a driver belt pulley 135, based on the hydraulic fluid received from the valve assembly 110. For example, the rotor assembly 115 includes the driver belt pulley 135, a driven belt pulley 140, and a belt 145 coupled between the driver belt pulley 135 and the driven belt pulley 140. An engine 210 may be coupled to the driver belt pulley 135 and configured to propel the driver belt pulley 135. The hydraulic cylinder 130 is coupled to the driver belt pulley 135 and configured to move side plates 150 of the driver belt pulley 135 closer together or farther apart to control the effective diameter of the driver belt pulley 135. Changing the effective diameter of the driver belt pulley 135 changes a rotational speed of the driver belt pulley 135. For example, moving the side plates 150 closer together increases the effective diameter of the belt 145 coupled to the driver belt pulley 135 and increases a rotational speed of the driver belt pulley 135. Moving the side plates 150 further apart decreases the effective diameter of the belt 145 coupled to the driver belt pulley 135 and decreases the rotational speed of the driver belt pulley 135. In at least one example embodiment, the rotor 125 is coupled to the driven belt pulley 140 via a shaft 205 and the gear box 200 such that the rotational speed of the driven belt pulley 140 is configured to control a rotational speed of the rotor 125.

In at least one example embodiment, the valve assembly 110 is coupled to the rotor assembly 115. For example, the valve assembly 110 may be configured to supply the hydraulic fluid to the hydraulic cylinder 130 of the driver belt pulley 135, such as by a hydraulic line 155 coupled between the valve assembly 110 and the hydraulic cylinder 130. In at least one example embodiment, the valve assembly 110 may be configured to deliver or increase a pressure supplied to the hydraulic cylinder 130. Delivering or increasing the pressure may cause the side plates 150 of the driver belt pulley 135 to move closer together, thereby increasing the effective diameter of the belt 145 and increasing a rotational speed of the driver belt pulley 135. Relieving or decreasing the pressure supplied to the hydraulic cylinder 130 may cause the side plates 150 to move farther apart, thereby decreasing the effective diameter of the belt 145 and decreasing the rotational speed of the driver belt pulley 135.

In at least one example embodiment, a speed sensor 215 may be coupled to the rotor assembly 115. For example, the speed sensor 215 may be coupled to the gear box 200 of the rotor assembly 115. The controller 105 may be configured to receive a speed signal from the speed sensor 215 indicating a current rotational speed of the driver belt pulley 135 and/or the rotor 125. Based on the speed signal, the controller 105 may be configured to adjust the hydraulic pressure delivered to the hydraulic cylinder 130 from the valve assembly 110 to increase, decrease, or maintain the pressure of the hydraulic fluid delivered to the hydraulic cylinder 130, as set forth above. By controlling the pressure delivered to the hydraulic cylinder 130, the controller 105 may control the speed of the driver belt pulley 135 and the rotor 125 within a speed range associated with the gear setting selected by the operator.

In at least one example embodiment, the rotor assembly 115 may include a pressure sensor coupled to the hydraulic cylinder 130. The controller 105 may be configured to receive a pressure signal from the pressure sensor and adjust the hydraulic pressure delivered to the hydraulic cylinder 130, and thus the effective diameter of the driver belt pulley 135, in or order to control the rotational speed of the driver belt pulley 135 and the rotor 125. In at least one example embodiment, the hydraulic pressure delivered to the hydraulic cylinder 130 may be between about 0 kilopascals (kPa) and about 200,000 kPa. In at least one example embodiment, the hydraulic pressure delivered to the hydraulic cylinder 130 may be between about 0 pounds per square inch (PSI) and about 30,000 PSI.

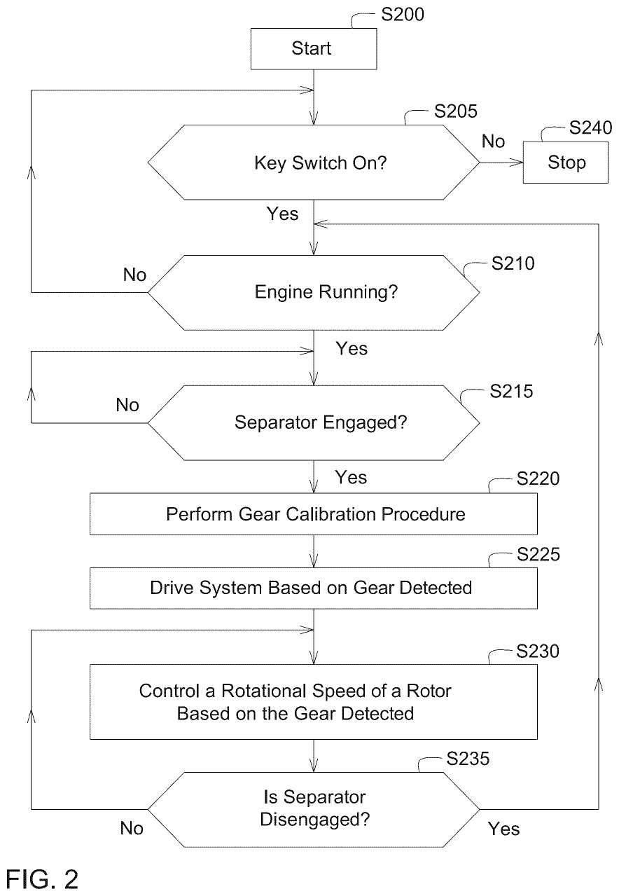

FIG. 2 is a flow chart of a method for operating a rotor of the agricultural harvester in accordance with at least one example embodiment.

In at least one example embodiment, the method begins at S200 and generally includes determining whether a key switch of the harvester 160 is on at S205, determining whether an engine, such as the engine 210, of the harvester 160 is running at S210, determining whether a separator, such as the separator 116, of the harvester 160 is engaged at S215, performing a gear detection procedure at S220, operating the harvester 160 based on a gear detected at S225, controlling a rotational speed of a rotor based on the gear detected at S230, and determining whether the separator 116 of the harvester 160 is disengaged at S235. Each of the steps is described in greater detail below.

In at least one example embodiment, the method begins at S200. At S200, the method may begin when an operator selects a gear setting and/or engages a clutch of the harvester 160. The method may then proceed to determining whether the key switch is on at S205. The operator of the harvester 160 may engage the key switch in order to power on the harvester 160. If the key switch is not on at S205, then the method is stopped at S240. If the key switch of the harvester 160 is on at S205, then the method proceeds to S210.

In at least one example embodiment, the method includes determining if the engine 210 of the harvester 160 is running at S210. If it is determined that the engine 210 is not running at step S210, then the method returns to S205 to determine whether the key switch of the harvester 160 is on. If the engine is running at S210, then the method proceeds to S215.

In at least one example embodiment, the method includes determining whether the separator 116 of the harvester 160 is engaged at S215. When the separator 116 is engaged, the rotor 125 may be configured to engage the crops being harvested during movement of the harvester 160. When the separator 116 is disengaged, the rotor 125 of the harvester 160 is inactive such that crops are not harvested during movement of the harvester 160. If the separator 116 is not engaged, the method returns to S215. If the separator 116 is engaged, then the method proceeds to S220.

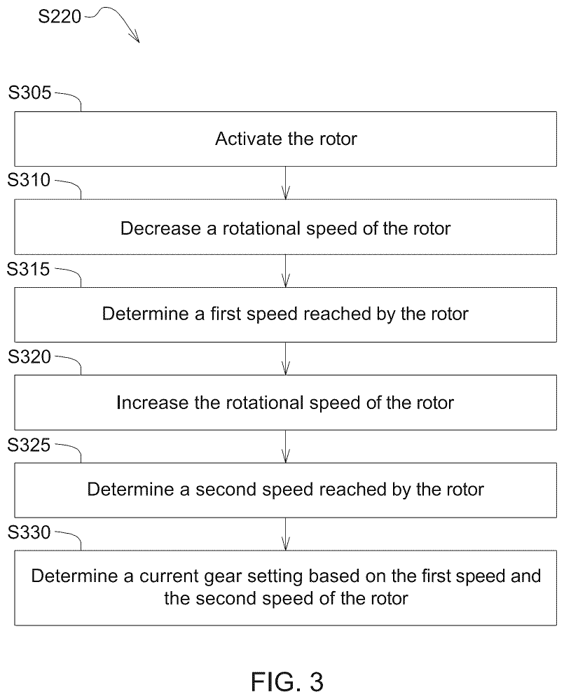

In at least one example embodiment, the method includes performing a gear calibration procedure at S220. The gear calibration procedure S220 will be discussed in more detail below with respect to FIG. 3. The gear calibration procedure S220 is configured to determine or detect a gear setting of the rotor assembly 115. After performing the gear calibration procedure at S220, the rotor 125 may be operated according to the gear detected or obtained. Additionally, the rotational speed of the rotor 125 may be controlled at S230 based on the gear detected. For example, the controller 105 may control delivery of hydraulic fluid to the hydraulic cylinder 130 rotor assembly 115, as described above with respect to FIG. 1, such that the rotational speed of the driver belt pulley 135 and the driven belt pulley 140, and thereby the rotor 125, is within a range or threshold associated with the detected gear. Additionally or alternatively, the rotor 125 may be operated at a speed set by the operator. For example, if the first gear having a first gear threshold between about 210 RPM to about 500 RPM is detected, the operator may set the rotational speed of the rotor 125 within the first gear threshold. Similarly, if the second gear having the second gear threshold between about 400 RPM to about 1000 RPM is detected, the operator may set the rotational speed of the rotor 125 within the second gear threshold.

In at least one example embodiment, the method includes determining whether the separator 116 is disengaged at S235. If the separator 116 is still engaged at S235, then the method returns to S230 and the rotational speed of the rotor 125 continues to be controlled by the gear detected at S220. If the separator 116 is disengaged at S235, then the method returns to S210.

FIG. 3 is a flow chart of a gear calibration method for the rotor of the agricultural harvester in accordance with at least one example embodiment.

In at least one example embodiment, the gear calibration procedure of S220 of FIG. 2 includes a method for calibrating a gear position of the rotor assembly 115 of the harvester 160. The method S220 generally includes activating the rotor 125 at S305, decreasing a rotational speed of the rotor 125 at S310, determining a first rotational speed reached by the rotor 125 at S315, increasing the rotational speed of the rotor 125 at S320, determining a second rotational speed reached by the rotor 125 at S325, and determining or obtaining a current gear setting of the rotor assembly 115 based on the first rotational speed and the second rotational speed reached by the rotor 125 at S330. Each of the steps is described in greater detail below.

In at least one example embodiment, the method includes activating the rotor 125 at S305. The rotor 125 may be activated by the controller 105. For example, the controller 105 may be configured to cause the valve assembly 110 to deliver hydraulic fluid to the hydraulic cylinder 130 of the rotor assembly 115 to increase or decrease the rotational speed of the driver belt pulley 135, the driven belt pulley 140, and the rotor 125, as described above with respect to FIG. 1B.

In at least one example embodiment, the method includes decreasing the rotational speed of the rotor 125 at S310. The controller 105 may control the hydraulic fluid delivered from the valve assembly 110 to the hydraulic cylinder 130 of the rotor assembly 115, as described above with respect to FIG. 1B, in order to rotate the driver belt pulley 135, the driven belt pulley 140, and the rotor 125 at a first speed or a first rotational speed. For example, the controller 105 may decrease the hydraulic pressure delivered to the hydraulic cylinder 130 such that the side plates 150 move farther apart, which decreases the diameter of the belt 145 and decreases the rotational speed of the driver belt pulley 135, the driven belt pulley 140, and the rotor 125. For example, the hydraulic pressure delivered to the hydraulic cylinder 130 may be decreased to 0 kPa. The first speed may be a minimum rotational speed or lower limit attainable by the rotor 125 in a current gear setting of the rotor 125. In at least one example embodiment, decreasing the speed of the rotor 125 may include decreasing the speed of the rotor 125 until the side plates 150 of the driver belt pulley 135 stall, at which point the first speed, such as the minimum speed, of the rotor 125 may be reached. The rotor 125, and the hydraulic cylinder 130, may stall when hydraulic pressure is being delivered to the hydraulic cylinder 130 but little to no movement of the hydraulic cylinder 130 and/or rotor 125 occurs.

In at least one example embodiment, the method includes determining the first speed reached by the rotor 125 at S315. The first speed reached by the rotor 125 may include the minimum rotational speed reached by the rotor 125 before the side plates 150 of the driver belt pulley 135 stall. In at least one example embodiment, the method further includes storing the first speed reached by the rotor 125 in a memory of the harvester. For example, the controller 105 may include a memory and programming, such as algorithms. In at least one example embodiment, operations and methods described herein as being performed by the controller 105 may be performed by processing circuitry. The term “processing circuitry,” as used in the present disclosure, may refer to, for example, hardware including logic circuits; a hardware/software combination such as a processor executing software; or a combination thereof. For example, the hardware more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

In at least one example embodiment, the method includes increasing the rotational speed of the rotor 125 at S320. The controller 105 may control the hydraulic fluid delivered from the valve assembly 110 to the hydraulic cylinder 130 of the rotor assembly 115, as described above with respect to FIG. 1B, in order to rotate the driver belt pulley 135, the driven belt pulley 140, and the rotor 125 at a second speed or a second rotational speed. For example, the controller 105 may increase the hydraulic pressure delivered to the hydraulic cylinder 130 such that the side plates 150 move closer together, which increases the diameter of the belt 145 and increases the rotational speed of the driver belt pulley 135, the driven belt pulley 140, and the rotor 125. The second speed may be a maximum rotational speed or upper limit attainable in the current gear setting of the rotor 125. In at least one example embodiment, increasing the speed of the rotor 125 may include increasing the speed of the rotor 125 until the rotor 125 stalls, at which point the second speed, such as the maximum speed, of the rotor 125 may be reached.

In at least one example embodiment, the method includes determining the second speed reached by the rotor 125 at S325. The second speed reached by the rotor 125 may include the maximum rotational speed reached by the rotor 125 before the side plates 150 of the driver belt pulley 135 stall. In at least one example embodiment, the method further includes storing the second speed in the memory of the harvester.

In at least one example embodiment, the speed direction of the rotor 125 may be optimized based on a previous speed setting of the rotor 125 set by the operator of the harvester 160. For example, the rotational speed of the rotor 125 may be increased at S310 if the previous speed setting set by the operator was higher. In such embodiments, the rotational speed of the rotor 125 would then be decreased at S320. In other words, the steps of decreasing the rotational speed of the rotor at S310 and increasing the rotational speed of the rotor 125 at S320 may be swapped based on the previous speed setting set by the operator before the gear calibration procedure S220 begins. Such optimization of speed may reduce the amount of time required to perform the gear calibration procedure S220.

In at least one example embodiment, the method includes determining the current gear setting based on the first speed and the second speed of the rotor 125 at S330. The current gear setting may be determined by comparing one or both of the first speed and the second speed of the rotor 125 to a speed threshold of two or more gear settings. In at least one example embodiment, the two or more gear setting include the first gear having the first gear threshold and the second gear having the second gear threshold. For example, as set forth above, the first gear threshold may be between about 210 RPM to about 500 RPM and the second gear threshold may be between about 400 RPM to about 1000 RPM. The current gear may be the first gear when the first speed and the second speed are within the first gear threshold or the current gear setting may be the second gear if the first speed and the second speed are within the second gear threshold.

In at least one example embodiment, the first speed or the second speed may be within an overlapping region of the first gear threshold and the second gear threshold. For example, the rotational speeds of the first gear threshold and the second threshold may overlap but have different minimum and maximum rotational speeds. In the example set forth above, the first gear threshold and the second gear threshold overlap between about 400 RPM and 550 RPM. In such embodiments, the current gear setting is the first gear if the first speed is less than or equal to a minimum speed of the second gear threshold and the second speed is less than or equal to a maximum speed of the first gear threshold. The current gear setting is also the first gear if the first speed is greater than or equal to a minimum speed of the first gear threshold and the second speed is less than or equal to the minimum speed of the second gear threshold. The current gear setting is the second gear if the second speed is greater than or equal to a maximum speed of the first gear threshold and the first speed is greater than or equal to the minimum speed of the second gear threshold. The current gear setting is also the second gear if the first speed is greater than or equal to the maximum speed of the first gear threshold and the second speed is less than or equal to the maximum speed of the second gear threshold.

In at least one example embodiment, the at least two gear setting may include the first gear, the second gear, and a third gear. The first gear, the second gear, and the third gear may each include the first gear threshold, the second gear threshold, and a third gear threshold, respectively. For example, the first gear threshold may be between about 300 RPM and about 520 RPM, the second gear threshold may be between about 420 RPM and about 800 RPM, and the third gear threshold may be between about 720 RPM and about 1300 RPM in some example embodiments. The current gear may be the first gear when the first speed and the second speed are within the first gear threshold, the current gear setting may be the second gear if the first speed and the second speed are within the second gear threshold, and the current gear setting may be the third gear if the first speed and the second speed are within the third gear threshold.

In at least one example embodiment, the first speed or the second speed may be within an overlapping region of the first gear threshold and the second gear threshold or an overlapping region of the second gear threshold and the third gear threshold. For example, the rotational speeds of the first gear threshold and the second threshold may overlap but have different lower limits, or minimum rotational speeds, and upper limits, or maximum rotational speeds, and the rotational speeds of the second gear threshold and the third gear threshold may overlap but have different minimum and maximum rotational speeds. In the example set forth above, the overlapping region between the first gear threshold and the second gear threshold may be between about 420 RPM and about 520 RPM and the overlapping region of the second gear threshold and the third gear threshold may be between about 720 RPM and about 800 RPM.

In at least one example embodiment, the current gear setting is the first gear if the first speed is less than or equal to the minimum speed of the second gear threshold and the second speed is less than or equal to a maximum speed of the first gear threshold. The current gear setting is the second gear if the first speed is less than or equal to a minimum speed of the third gear threshold and the second speed is less than or equal to a maximum speed of the second gear threshold. The current gear setting is the second gear if the second speed is greater than or equal to the maximum speed of the first gear threshold and the first speed is greater than or equal to the minimum speed of the second gear threshold. The current gear setting is the third gear if the second speed is greater than or equal to the maximum speed of the second gear threshold and the first speed is greater than or equal to the minimum speed of the third gear threshold. The current gear setting is also the third gear if the first speed is greater than or equal to the maximum of the second gear threshold and the second speed is less than or equal to a maximum of the third gear threshold.

After determining the current gear setting at S330, the rotor 125 may be operated according to the gear detected at S225 and the rotational speed of the rotor 125 may be controlled at S230 as set forth above with respect to FIG. 2. For example, the operator may set the rotational speed of the rotor 125 within the threshold of rotational speeds for the current gear setting. In at least one example embodiment, the rotational speed of the rotor 125 may be returned to a prior rotational speed value set by the operator before performing the gear calibration procedure S220.

In at least one example embodiment, the gear calibration procedure of S220 may determine whether the gear setting has been changed since a prior gear setting set by the operator was last recorded or stored in the memory of the harvester 160. For example, the prior gear setting may be the first gear including the first gear threshold ranging from about 210 RPM to about 500 RPM, as set forth above with respect to FIG. 1B. However, if the gear calibration procedure S220 determines that the current gear setting is not the first gear, this may indicate that the operator changed the gear setting. For example, the operator may have changed the gear setting from the first gear to the second gear or the third gear. If it is determined that the gear setting has been changed, the rotational speed of the rotor may be controlled within the threshold of rotational speeds of the current gear setting. If it is determined that the gear setting has not been changed, the rotational speed of the rotor 125 may be returned to the prior rotational speed value previously selected by the operator of the harvester.

The various operations of methods described above may be performed by any suitable device capable of performing the operations, such as the controller 105 and/or the processing circuitry discussed above. For example, as discussed above, the operations of methods described above may be performed by various hardware and/or software implemented in some form of hardware (e.g., processor, ASIC, etc.).

The software may comprise an ordered listing of executable instructions for implementing logical functions, and may be embodied in any “processor-readable medium” for use by or in connection with an instruction execution system, apparatus, or device, such as a single or multiple-core processor or processor-containing system.

The blocks or operations of a method or algorithm and functions described in connection with some example embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium (e.g., the memory).

According to some example embodiments, the memory disclosed herein may be a tangible, non-transitory computer-readable medium, such as a Random Access Memory (RAM), a flash memory, a Read Only Memory (ROM), an Electrically Programmable ROM (EPROM), an Electrically Erasable Programmable ROM (EEPROM), registers, a hard disk, a removable disk, a Compact Disk (CD) ROM, any combination thereof, or any other form of storage medium known in the art.

Example embodiments have been disclosed herein, it should be understood that other variations may be possible. Such variations are not to be regarded as a departure from the spirit and scope of the present disclosure, and all such modifications as would be obvious to one skilled in the art are intended to be included within the scope of the following claims.

We claim:

1. A non-transitory computer-readable medium storing instructions that, when executed by at least one processor, causes the at least one processor to perform a method, the method comprising:
performing a gear calibration procedure;
obtaining a gear setting based on the gear calibration procedure; and
controlling a rotational speed of a rotor based on the obtained gear setting.

2. The non-transitory computer-readable medium of claim 1, wherein the performing the gear calibration procedure comprises:
activating the rotor;
decreasing the rotational speed of the rotor;
determining, as a first rotational speed, a rotational speed achieved by the rotor prior to plates of a variable drive unit experiencing a stall when the rotational speed of the rotor is decreased;
increasing the rotational speed of the rotor;
determining, as a second rotational speed, a rotational speed achieved by the rotor prior to the plates of the variable drive unit experiencing a stall when the rotational speed of the rotor is increased; and
determining a current gear setting based on the first rotational speed and the second rotational speed.

3. The non-transitory computer-readable medium of claim 2, wherein:
the decreasing the rotational speed of the rotor includes reducing a hydraulic pressure delivered to the rotor; and
the increasing the rotational speed of the rotor includes increasing the hydraulic pressure delivered to the rotor.

4. The non-transitory computer-readable medium of claim 2, wherein:
the decreasing the rotational speed of the rotor includes increasing a distance between two side plates of a variable drive unit coupled to the rotor; and
the increasing to the rotational speed of the rotor includes decreasing the distance between the two side plates of the variable drive unit coupled to the rotor.

5. The non-transitory computer-readable medium of claim 2, wherein the determining the current gear setting includes comparing the first rotational speed and the second rotational speed to two or more gear thresholds.

6. The non-transitory computer-readable medium of claim 5, wherein:
the two or more gear thresholds include a first gear threshold and a second gear threshold;
the current gear setting is a first gear if the first rotational speed is less than or equal to a lower limit of the second gear threshold and the second rotational speed is less than or equal to an upper limit of the first gear threshold; and
the current gear setting is a second gear if the second rotational speed is greater than or equal to an upper limit of the first gear threshold and the first rotational speed is greater than or equal to a lower limit of the second gear threshold.

7. The non-transitory computer-readable medium of claim 5, wherein:
the two or more gear thresholds include a first gear threshold, a second gear threshold, and a third gear threshold;
the current gear setting is a first gear if the first rotational speed is less than or equal to a lower limit of the second gear threshold and the second rotational speed is less than or equal to an upper limit of the first gear threshold;
the current gear setting is a second gear if the first rotational speed is less than or equal to a lower limit of the third gear threshold and the second rotational speed is less than or equal to upper limit of the second gear threshold;
the current gear setting is the second gear if the second rotational speed is greater than or equal to an upper limit of the first gear threshold and the first rotational speed is greater than or equal to a lower limit of the second gear threshold; and
the current gear setting is a third gear if the second rotational speed is greater than or equal to the upper limit of the second gear threshold and the first rotational speed is greater than or equal to the lower limit of the third gear threshold.

8. A system comprising:
a rotor assembly;
a valve assembly communicatively coupled to the rotor assembly; and
a controller communicatively coupled to the valve assembly, the controller configured to:
perform a gear calibration procedure,
obtain a gear setting based on the gear calibration procedure, and
control a rotational speed of a rotor based on the obtained gear setting.

9. The system of claim 8, wherein the gear calibration procedure comprises:
activating the rotor;
decreasing the rotational speed of the rotor;
determining, as a first rotational speed, a rotational speed achieved by the rotor prior to plates of a variable drive unit experiencing a stall when the rotational speed of the rotor is decreased;
increasing the rotational speed of the rotor;
determining, as a second rotational speed, a rotational speed reached by the rotor prior to the plates of the variable drive unit experiencing a stall when the rotational speed of the rotor is increased; and
determining a current gear setting based on the first rotational speed and the second rotational speed.

10. The system of claim 9, wherein:
the decreasing the rotational speed of the rotor includes reducing a hydraulic pressure delivered to the rotor; and
the increasing the rotational speed of the rotor includes increasing a hydraulic pressure delivered to the rotor.

11. The system of claim 9, wherein the obtained gear setting comprises a first gear having a first gear threshold or a second gear having a second gear threshold.

12. The system of claim 11, wherein:
the current gear setting is a first gear if the first rotational speed is less than or equal to a lower limit of the second gear threshold and the second rotational speed is less than or equal to an upper limit of the first gear threshold; and
the current gear setting is a second gear if the second rotational speed is greater than or equal to an upper limit of the first gear threshold and the first rotational speed is greater than or equal to a lower limit of the second gear threshold.

13. The system of claim 9, wherein the obtained gear setting comprises a first gear having a first gear threshold, a second gear having a second gear threshold, or a third gear having a third gear threshold.

14. The system of claim 13, wherein:
the current gear setting is a first gear if the first rotational speed is less than or equal to a lower limit of the second gear threshold and the second rotational speed is less than or equal to an upper limit of the first gear threshold;
the current gear setting is a second gear if the first rotational speed is less than or equal to a lower limit of the third gear threshold and the second rotational speed is less than or equal to an upper limit of the second gear threshold;
the current gear setting is the second gear if the second rotational speed is greater than or equal to an upper limit of the first gear threshold and the first rotational speed is greater than or equal to a lower limit of the second gear threshold; and
the current gear setting is a third gear if the second rotational speed is greater than or equal to the upper limit of the second gear threshold and the first rotational speed is greater than or equal to the lower limit of the third gear threshold.

15. The system of claim 9, further comprising a sensor coupled to the rotor and configured to measure the rotational speed of the rotor.

16. A method comprising:
performing a gear calibration procedure for a rotor assembly of an agricultural harvester;
obtaining a gear based on the gear calibration procedure; and
controlling a rotational speed of a rotor of the rotor assembly based on the obtained gear setting.

17. The method of claim 16, wherein the gear calibration procedure comprises:
activating the rotor;
decreasing the rotational speed of the rotor;
determining, as a first rotational speed, a rotational speed achieved by the rotor prior to plates of a variable drive unit experiencing a stall when the rotational speed of the rotor is decreased;
increasing the rotational speed of the rotor;
determining, as a second rotational speed, a rotational speed achieved by the rotor prior to the plates of the variable drive unit experiencing a stall when the rotational speed of the rotor is increased; and
determining a current gear setting based on the first rotational speed and the second rotational speed.

18. The method of claim 17, wherein:
the determining the current gear setting comprises comparing the first rotational speed and the second rotational speed to a first gear threshold and a second gear threshold;
the current gear setting is a first gear if the first rotational speed is less than or equal to a lower limit of the second gear threshold and the second rotational speed is less than or equal to an upper limit of the first gear threshold; and
the current gear setting is a second gear if the second rotational speed is greater than or equal to an upper limit of the first gear threshold and the first rotational speed is greater than or equal to a lower limit of the second gear threshold.

19. The method of claim 18, wherein:
the determining the current gear setting further comprises comparing the first rotational speed and the second rotational speed to a third gear threshold;
the current gear setting is a first gear if the first rotational speed is less than or equal to a lower limit of the second gear threshold and the second rotational speed is less than or equal to an upper limit of the first gear threshold;
the current gear setting is a second gear if the first rotational speed is less than or equal to a lower limit of the third gear threshold and the second rotational speed is less than or equal to an upper limit of the second gear threshold;
the current gear setting is the second gear if the second rotational speed is greater than or equal to an upper limit of the first gear threshold and the first rotational speed is greater than or equal to a lower limit of the second gear threshold; and
the current gear setting is a third gear if the second rotational speed is greater than or equal to the upper limit of the second gear threshold and the first rotational speed is greater than or equal to the lower limit of the third gear threshold.

20. The method of claim 16, wherein the controlling the rotational speed of the rotor includes operating the rotor at a prior rotational speed value selected by an operator.
